(19) United States
(12) Patent Application Publication
(10) Pub. No.: US 2007/0095113 A1
(43) Pub. Date: May 3, 2007

(54) Valve locking device

(76) Inventor: Philip Hazelett, Brea, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/265,645

(22) Filed: Nov. 2, 2005

(51) Int. Cl. F16K 35/10

(52) U.S. Cl. 70/178

(57) ABSTRACT

In a valve locking device, an elongated lock attachment arm with a hollow base element is connected to a nut element of a valve assembly. The device is secured by attaching steel cables to apertures in the elongated lock attachment arm by a padlock. The valve locking device prevents the manipulating or tampering of water and gas valves by terrorists and vandals.

### BACKGROUND OF THE INVENTION

1. Field of the Invention

The field of the invention relates to security lock devices. Specifically, this invention is designed to prevent individuals from tampering with gas and water supplies by locking the shut-off valve mechanism and preventing unwanted access, while indicating the statues of the protected valve, which remains in the position, open or shut, that is has when the invention is applied.

2. Description of Related Art

Throughout the United States, water and gas are supplied to households, apartment buildings and commercial buildings through a series of intricate pipeline systems. All of these pipelines utilize shut-off valves for the purpose of eliminating the flow of water or gas in an emergency or when the pipeline needs to be repaired. In emergency situations such as a fire or explosion, the valves are also used to control the flow of water out of the pipeline when required by the fire department. Due to the important functions of such valves, there is a growing need to protect them from acts of terrorism and vandalism.

Vandalizing of the valves could result in drastic consequences if emergency situations should arise. The inability to shut down a particular gas or water pipeline that contains a leak could result severe property damage or physical injury. Water pipelines have a tendency to burst or leak and could cause flooding and property damage if there is no way to turn off the flow of water. In addition, a severe gas leak could lead to a major health and safety issue. Continued exposure to methane eventually leads to depletion of oxygen levels and eventual suffocation and increased methane levels create a greater likelihood of an explosion.

Terrorists could attempt to disable the water valves and destroy important industrial areas such as railroads and refineries by starting fires and creating explosions. The inability to obtain water from the pipelines immediately could result in increased damage and destruction to the particular industrial site. In addition, it could result in a greater loss of life due to increased flames from the inability to put the fire out quickly. In response to these concerns, prior art has attempted to solve these problems.

For example, U.S. Pat. No. 6,354,116 issued on Mar. 12, 2002 to inventor Drake discloses a small valve cover, with built in locking mechanism, to be used for locking gas pipelines at individual homes. Although this accomplishes the same end result, the prior art does not operate in the same way as the present invention and it is unsuitable for large scale pipelines.

Another attempt to remedy the problem can be observed in U.S. Pat. No. 6,354,116 issued May 28, 1929 to P. S. Douglas. This discloses a valve locking device which prevents the operation of a valve handle so that the position of the wheel valve cannot be altered. This is accomplished by mounting a locking device on the valve body, so that the locking device swings down upon and engages the valve operating wheel with a pair of stops extending downward between spokes of the valve operating wheel. Although this is a viable way to prevent the tampering of such devices, this wheel-based protection system is extremely expensive and cumbersome.

U.S. Pat. No. 5,469,724 issued Nov. 28, 1995 to Jerry Pollard discloses a fire hydrant locking device that prevents the operating nut from being accessed while not in use. The operating nut is secured through a metal arm and pad lock. This prior art fails to provide a viable means for securing an operating valve which employs a hand wheel.

Finally, U.S. Pat. No. 4,964,613 issued Oct. 23, 1990 to Timothy Logman and later assigned to the Meuller Co. of Decatur, Ill. discloses a modern day hand valve that would utilize the present invention. The prior art discloses a valve assembly having a bonnet with a nut element and valve status indicator disk at its upper end and a through passage within said nut element and said valve status indicator disk for the attachment of an operating stem. This prior art fails to provide as sufficient security means for preventing tampering with such devices.

A problem common to all of the prior art is that each invention fails to provide a safe and inexpensive security means for protecting the emergency shut-off valves associated with water and gas pipelines. The present invention provides a simple and innovative way of protecting these valves from vandalism and terrorism. Since it is composed of a sturdy, inexpensive material, industries can utilize these protective devices rather than employ a more expensive wheel handle system with a less secure padlock.

### BRIEF SUMMARY OF THE INVENTION

The present invention consists of a rectangular, elongated padlock attachment member with a square base connected to said member forming a T-shaped security device. The square base is hollow and its dimensions allow the T-shaped device to fit snugly over a nut or other valve connection of a shut-off valve. Preferably, the device is composed of hardened steel or some other strong, sturdy metal, and it is thick enough to have a tensile strength of at least 300 lbs. This prevents the valves and hand wheels from being tampered with or damaged.

It is therefore, the object of the present invention to provide an improved valve security device to prevent terrorists or vandals from tampering or damaging said device.

Another object of the present invention is to create a durable, strong valve security device that is capable of enduring exterior forces of 300 lbs. or greater

Another object of the invention is to provide a device, which may be detachably secured to a hand wheel attachment and locked to prevent manipulation of the valve.

It is a further object of the present invention to provide a valve security device, which is simple in design and inexpensive to construct, is durable and rugged in structure, and can be easily fit or retrofit to new and existing hand wheel attachment.

It is still another object of the present invention to provide a valve security device which secures and protects the valve, but which can be removed quickly and easily when access is needed for municipal use.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

FIG. 1 is a cross-sectional view of the upper portion of a prior art valve assembly.

FIG. 2 is a perspective view of the nut element for the operating stem attachment of the valve assembly, with the T-shaped locking device of the current invention directly overhead of the nut element.

FIG. 2a is a side view of the nut element for the operating stem attachment of the valve assembly, after the T-shaped locking device of the current invention has been attached atop of the nut element.

FIG. 3 is a perspective view of the T-shaped device securely placed over the nut element of the valve assembly and secured with padlocks.

FIG. 4 is a perspective view of the T-shaped device secured to the valve assembly through padlocks connected to the T-shaped device and thick wire looped around the valve assembly.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

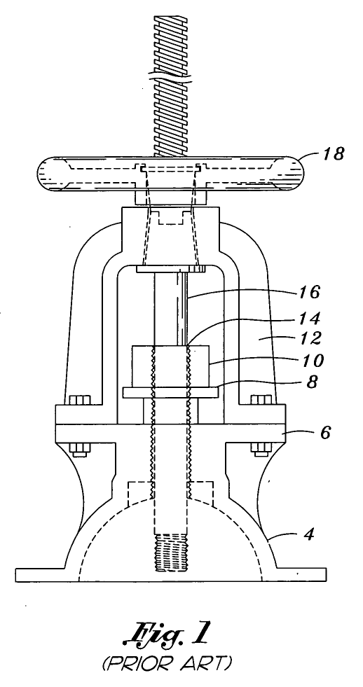

Referring to FIG. 1, this represents the upper portion of a Prior Art valve assembly 2. The upper portion of the prior art valve assembly 2 is divided into two sections. The first section comprises a yoke 12, while the second section is comprised of a bonnet 4. The yoke 12 encloses the exposed portion of the operating stem 16 and is attached to the bonnet 4 by a series of bolts 6 at the base of said yoke.

Attached to the apex of the bonnet 4 is a nut element 10 with an attached valve status indicator disk 8. The valve status indicator disk 8 allows the user to determine if the valve assembly 2 is in an open or closed position. Within said nut element 10 and said valve status indicator disk 8 is a through passage 14 that allows the operating stem 16 to extend into said bonnet 4. The operating stem 16 ultimately controls the operation of the valve assembly 2. At the exposed portion of the operating stem 16 is a hand wheel 18, which allows the user to open and close the valve through the operating stem 16. In order to utilize the present invention, the yoke 12, with attached operating stem 16 and hand wheel 18, is unbolted and removed from the valve assembly 2.

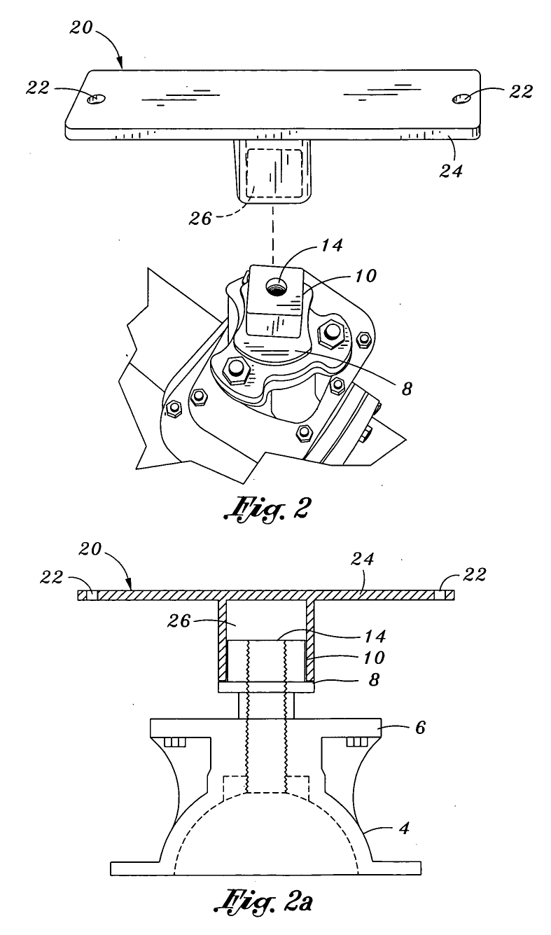

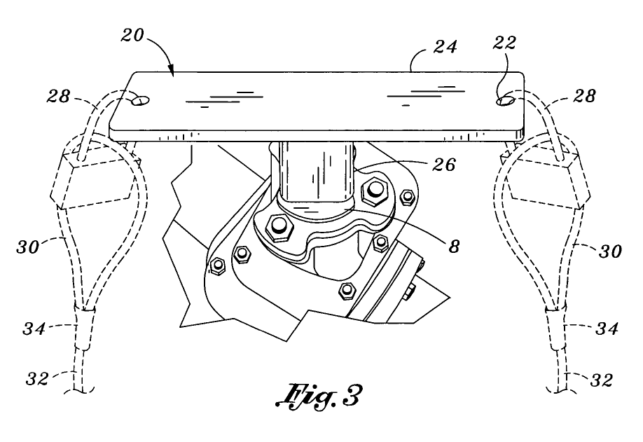

Referring to FIG. 2, this illustrates an exploded view of the nut element 10 with a valve status indicator disk 8 and a perspective view of the locking device 20 of the current invention, hovering over said nut element 10. The locking device 20—which in a preferred embodiment is composed of a strong, sever-resistant material such as steel—is comprised of a rectangular, elongated lock attachment arm 24 with a hollow base element 26 located at an intermediate point along the arm 24. Preferably, the hollow base element 10 is positioned in the center of the elongated lock attachment arm 24 creating a T-shaped device. Located at both ends of the rectangular, elongated lock attachment arm 24 are apertures 22 for the attachment of a steel cable to the locking device 20. This will be further discussed in FIG. 3.

As illustrated in FIG. 2a, the hollow base element 26 is lowered into position over the nut element 10 and conformably fits over said nut element 10, thereby preventing tampering and manipulation of the valve assembly 2. The placement of the hollow base element 26 does not obstruct the valve status indicator disk 8 from being viewed. This allows an observer to determine whether the valve assembly 2 is in an opened or closed position while the locking device 20 is in place. The valve status indicator disk 8 is seen un-obscured by the locking device even in place in FIG. 3.

Referring to FIG. 3, this illustrates an exploded view of the locking device 20 secured to the nut element 10 by a sever-resistant, steel cable 34 and fastening attachment means. The fastening attachment means is comprised of a padlock 28 and fastening loops 30 positioned at each end of the steel cable 34. In order to create the fastening loops 30, a loop clasp 34 is attached at an intermediate point on the steel cable 34. The end of the steel cable 34 is then attached to said intermediate point by the loop clasp 34, thereby creating a fastening loop 30 at each end of the steel cable 34. Attachment of the steel cable 34 to the elongated lock attachment arm 24 is accomplished by connecting the padlocks 28 to the fastening loops 30 and apertures 22 of the elongated lock attachment arm 24.

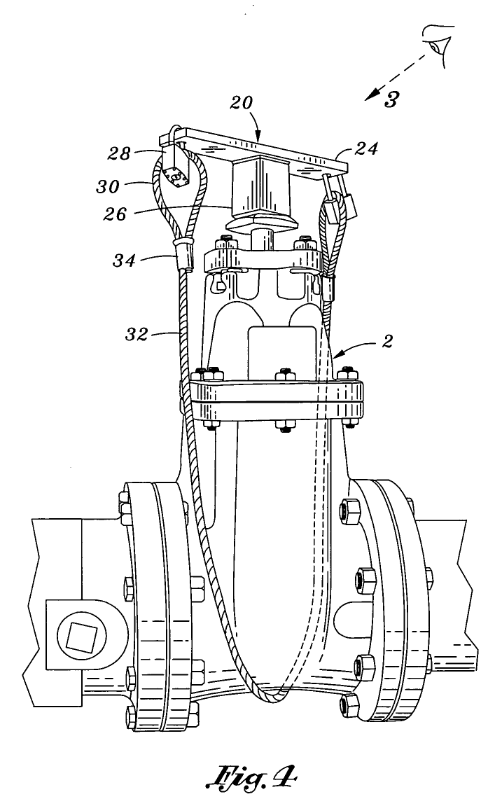

Referring to FIG. 4, this depicts a perspective view of the valve assembly 2 with the secured locking device 20 located at the top of said valve assembly 2. The locking device 20 is secured to the nut element 10 by looping the steel cable 34 around the valve assembly 2 and connecting each end of the steel cable 34 to an opposing aperture 22 of the elongated lock attachment arm 24 by said padlocks 28. This prevents unauthorized users from tampering or severely damaging the operation of the valve assembly 2.

The current invention is designed to comply with all current fire codes, including the NFPA, thee Los Angeles Fire District code, and other national and regional fire codes.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

1. A portable and removable locking device for a valve assembly, said locking device comprising:
an elongated lock attachment arm with a hollow base element, with said element located at an intermediate point along said arm;
said hollow base element conformably fitting over an upper nut element of said valve assembly, thereby enabling the secure placement of said locking device on top of said valve assembly;
means for securing said elongated lock attachment arm in place on said valve assembly,
wherein said hollow base is capable of being positioned to prevent obstruction of the external view of a valve status indicator disk of said valve assembly.

2. The locking device of claim 1, wherein said locking device is composed of an impact and sever-resistant material.

3. The locking device of claim 1, wherein said locking device is composed of steel.

4. The locking device of claim 1, wherein said elongated lock attachment arm contains a plurality of apertures positioned in various locations around said elongated lock attachment.

5. The locking device of claim 1, wherein said elongated lock attachment arm is rectangular in shape; and
wherein said elongated lock attachment arm has two apertures, with one aperture positioned at each end of said elongated lock attachment arm.

6. The locking device of claim 5, wherein said means for securing said elongated lock attachment arm comprises a sever resistant cable and fastening attachment means at each end of said cable; and wherein
said locking device is secured to the top of said valve assembly by connecting said fastening attachment means to said elongated lock attachment arm through said apertures.

7. The locking device of claim 6, wherein said fastening attachment means comprises a padlock and fastening attachment loops positioned at both ends of said cable.

8. (canceled)

9. The locking device of claim 1, wherein said hollow base is positioned in the center of said elongated lock attachment thereby creating a T-shaped device.

10. (canceled)

11. A locking device for a valve assembly, said locking device comprising:
an elongated lock attachment arm with a hollow base element, with said element located at an intermediate point along said arm;
said hollow base element conformably fitting over said nut element, thereby enabling the secure placement of said locking device on top of said valve assembly;
a strong cable, resistant to severing;
a fastening attachment means at each cad of said cable; wherein said locking device is capable of secure placement on top of said valve assembly through the interaction of said hollow base and said nut element; wherein,
said cable is connected to said elongated lock attachment arm by said fastening attachment means; and
wherein said hollow base is capable of being positioned to prevent obstruction of the external view of a valve status indicator disk of said valve assembly.

12. The locking device of claim 11, wherein said locking device is composed of an impact and sever-resistant material.

13. The locking device of claim 11, wherein said locking device is composed of hardened steel.

14. The locking device of claim 1 wherein said elongated lock attachment arm contains a plurality of apertures positioned In various locations around said elongated lock attachment arm.

15. The locking device of claim 11, wherein said elongated lock attachment arm is rectangular in shape;
wherein said elongated lock attachment arm has two apertures, with one aperture positioned at each end of said elongated lock attachment arm; and
said fastening attachment means is connected to said elongated lock attachment arm through said apertures.

16. The locking device of claim 11, wherein said hollow base is positioned in the center of said elongated lock attachment thereby creating a T-shaped device.

17. The locking device of claim 1 wherein said cable is composed of an impact and sever-resistant material.

18. The locking device of claim 1 wherein said cable is composed of hardened steel.

19. The locking device of claim 1 wherein said fastening attachment means comprises a padlock and attachment loops positioned at both ends of said cable.

20. (canceled)
